(19) United States
(12) Patent Application Publication
(10) Pub. No.: US 2002/0023187 A1
(43) Pub. Date: Feb. 21, 2002

(54) Computer system board having slots for operating different types of memory modules

(76) Inventors: Nai-Shung Chang, Taipei Hsien (TW); Shu-Hui Chen, Taipei Hsien (TW)

Correspondence Address: J.C. Patents, Inc., Suite 114, 1340 Reynolds Ave., Irvine, CA, 92614, US

(21) Appl. No.: 09/733,699

(22) Filed: Dec. 8, 2000

Related U.S. Application Data
(60) Provisional application No. 60/170,106, filed on Dec. 10, 1999.

(30) Foreign Application Priority Data
Jul. 5, 2000 (TW) 89113315

(51) Int. Cl. G06F 13/00

(52) U.S. Cl. 710/301

(57) ABSTRACT

A computer main board having a plurality of 184-lead memory module slots and a plurality of 168-lead memory module slots, a computer system, a terminal circuit module and memory modules that can be used in the main board and computer system. A control chipset on the main board can be preset so that any particular memory module on a memory module slot can be selected to operate in a special write mode. In other words, whether the write data has 64-bit length or not, a complete 64-bit data according to 64-bit (QW) block division is first read out and modified before writing the complete 64-bit data, In this invention, the wiring layout of the main board does not have to follow the signal line bit sequence. Al that is required is to connect each independent data line of the 16⁸-pin slot with each independent data line of the 184-pin memory module slot.

### CROSS-REFERENCE TO RELATED APPLICATION

This application claims the priority benefit of Taiwan application serial no. 89113315, filed Jul. 5, 2000, and U.S.A. provisional application serial no. 60/170,106, filed Dec. 10, 1999.

### BACKGROUNND OF THE INVENTION

1. Field of Invention

The present invention relates to a personal computer system capable of supporting different types of memory modules. More particularly, the present invention relates to the main board of a personal computer system having slots for operating two or more types of memory modules, at least synchronous dynamic random access memory and double-data-rate (DDR) dynamic random access memory.

2. Description of Related Art

Most personal computer system consists of a main board, interface cards and a few other peripheral devices. The main board is a critical component in a computer system. Besides having a central processing unit (CPU), a control chipset and a few slots for installing interface cards, the main board also includes a plurality of slots capable of inserting memory modules. In general, user can install different number of memory modules depending on specific design requirement and each memory module comprises a plurality of memory units

Synchronous dynamic random access memory (SDRAM) is often used in personal computers. SDRAM responds to the rising edge of a system clock cycle to carry out data transmission operation. Another type of memory is double-data-rate dynamic random access memory (DDR DRAM. When the DDR DRAM is operating at the double-data-rate mode, data transmission operation is carried out at both the rising and falling edge of a system clock cycle Hence, operating speed of the DDR DRAM is greatly increased.

The operating modes of SDRAM and DDR DRAM are different in many aspects, including (1) SDRAM uses normal clock pulse signals while DDR DRAM uses differential clock signals; (2) SDRAM uses V_{DD}=3.3 V while DDR DRAM uses V_{DD}=25 V and V_{DDQ}=2.5 V; (3) SDRAM does not require a reference voltage, but DDR DRAM requires a reference voltage whose value is about ½ V_{DDQ}; (4) SDRAM connects to a data bus that operates on CMOS logic while DDR DRAM connects to a data bus that operates on series-stub-termnated logic 2 (SSTL_{—}2); (5) there is no need for the SDRAM connected data bus connected to use a terminated voltage (V_{TT}), but DDR DRAM connected data bus must use a terminated voltage (V_{TT}) to absorb reflected waves; and (6) there is no need for the SDRAM connected data bus to use a pull-up resistor, but the DDR DRAM connected data bus must use a pull-up resistor. However, a DDR DRAM is able to operate at a speed roughly double that of the SDRAM.

Due to fundamental differences in design between different types of memory modules, most main boards in the market can only support one type of memory module such as SDRAM or DDR DRAM. Those main boards that support DDR DRAM memory modules use a memory module slot that follows a JEDEC 184-pin standard. On the other hand, those main boards that support SDRKM memory modules use a memory module slot that follows a 168-pin standard. The specification of signal pins between a 184-pin and a 168-pin standard is often very different. Moreover, the assignment of data signal lines between the 184-pin memory slot and the 168-pin memory slot is non-uniform. Thus, attempts to render a main board that supports 184-pin memory modules to support 168-pin memory modules or vice versa will increase not only layout area, but also signal attenuation as well.

At present, SDRAM memory modules are mass-produced with a relatively cheap market price. Price consideration makes customer opt for computer systems that use SDRAM memory modules. However, since DDR DRAM has a higher operating speed, customers often wish to have a main board that also supports DDR DRAM memory modules. When price of DDR DRAM memory module is right, DDR DRAM memory modules can be plugged into the main board to increase speed. Meanwhile, manufactures of computer main boards would like to have a main board that support both 184-pin DDR DRAM memory modules as well as 168-pin SDRAM memory modules because risk of production and stock-up can be greatly lowered.

FIG. 1 is a schematic diagram showing various components inside a conventional computer main board. As shown in FIG. 1, the main board 100 includes a control chipset 110 and a plurality of memory slots 120-150. Memory slots 120-150 are either 168-pin slot or 184-pin slot. If memory slots 120-150 are 168-pin slots, only 168-pin SDRAM memory modules can be used in main board 100, Hence, DDR DRAM memory modules cannot be used even if price of that modules drops in the future. Similarly, if memory slots 120-150 are 184-pin slots, only 184-pin DDR DRAM memory modules can be used in main board 100. Because DDR DRAM memory modules are still quite expensive, main boards 100 having 184-pin memory slots are still rare.

### SUMMARY OF THE INVENTION

Accordingly, one object of the present invention is to provide a main board having slots that can support both 184-pin memory modules and 168-pin memory modules. Both the 184-pin and 168-pin slots are capable of supporting DDR DRAM or SDRAM. Moreover, circuit layout on the main board is rather simple Besides the capacity to provide future compatibility, consumer can have more choices on the type of memory modules in addition to a lower risk of production and stockpiling.

A second object of this invention is to provide a 168-pin DDR DRAM memory module and a 168-pin terminal circuit module so that the composition of a computer system is more flexible.

A third object of this invention is to provide a computer system having a main board, a memory module and a matching terminal circuit module that can support both SDRAV and DDR DRAM type of memory modules.

To achieve these and other advantages and in accordance with the purpose of the invention, as embodied and broadly described herein, the invention provides a computer system having a main board with slots capable of supporting two or more types of memory modules. A main board having a plurality of slots is provided. The main board includes a plurality of slots for accommodating a first type memory module, a plurality of slots for accommodating a second type of memory module and a control chipset. Each of the three components includes a plurality of data pins. The data lead of the control chipset is connected sequentially to the corresponding data pins in the slots for the first type of memory module and randomly to the data pins in the slots for the second type of memory module. In addition, the control chipset has a special write mode, When the special write mode is activated and before data are written into the second type of memory modules, the 64-bit data according to the 64-bit block address is first read out from the memory module. After the data is modified according to the read-out 64-bit data, the post-modified 64-bit data are written into the memory module.

The slots for accommodating the first type of memory modules are designed according to JEDEC 184-pin specification or 224-pin specification, The slots for accommodating the second type of memory modules are designed according to 168-pin specification Furthermore, the control chipset can activate or terminate the special write mode, especially when data are access through second type of memory module slot, according to the target slot The special write mode can be activated or terminated through the basic input/output system (BIOS) inside a computer. Alternatively, the set values for the control chipset can be obtained from input/output port through computer's CPU.

This invention also provides a 168-pin DDR DRAG memory module that can be used on the main board of a computer system. The main board includes a plurality of 168-pin memory module slots. BEach memory module includes a printed circuit board that can be plugged into one of the 168-pin memory module slots and a plurality of DDR DRAM units on the printed circuit board.

This invention also provides a terminal circuit module that can be used on a main board. The main board includes a plurality of 168-pin memory module slots and each memory module slot includes a plurality of signal lines. The terminal circuit module includes a printed circuit board, a voltage regulator and a plurality of terminal resistors. The printed circuit board can be plugged into the memory module slot to provide electrical connection between the terminal circuit module and the memory module slot. The voltage regulator on the printed circuit board is used for providing a terminal voltage. The plurality of terminal resistors on the printed circuit board is coupled to the voltage regulator. One end of the terminal resistor is connected to one of the signal lines while the other terminal is connected to the terminal voltage.

The computer system according to this invention is applied to a main board having slots for accommodating a plurality of types of memory modules. The main board can support at least four types of memory modules including 184-pin DDR DRAM memory modules, 168-pin SDRAM memory modules, 184-pin SDRAM memory modules and 168-pin DDR DRAM memory modules. Consequently, memory modules having different pins can be incorporated into the main board of this invention. Note that when a memory module slot is occupied by a DDR DRAM memory module, another memory module slot is prevented from using SDRAM memory module. Moreover, when a DDR DRAM memory module is in use, a neighboring slot must have a terminal circuit module plugged in. The terminal circuit module can be plugged into a 168-pin or a 184-pin slot. When a memory module is plugged into a slot for the second type of memory module, the write mode is activated accordingly. Hence, when data need to be transferred from the control chipset to the second type of memory module, the 64-bit data according to the 64-bit block address is first read oat from the memory module, After the data is modified according to the read-out 64-bit data, the post-modified 64-bit data are written into the memory module

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic diagram showing various components inside a conventional computer main board;

FIG. 2 is a schematic diagram showing various components inside a computer main board according to one preferred embodiment of this invention;

FIG. 3A is a block diagram showing the activation of write mode in a computer main board by a resistor according to the preferred embodiment of this invention,

FIG. 3B is a block diagram showing the activation of write mode in a computer main board by a jumper according to the preferred embodiment of this invention;

FIG. 4A is a block diagram showing the activation of write mode in a computer main board by an input/output port and a coupled resistor according to the preferred embodiment of this invention;

FIG. 4B is a block diagram showing the activation of write mode in a computer main board by an input/output port and a jumper according to the preferred embodiment of this invention;

FIG. 5A is a portion of the circuit layout design on the component side of a computer main board according to the schematic diagram shown in FIG. 2;

FIG. 5B is a portion of the circuit layout design on the backside of a computer main board according to the schematic diagtam shown in FIG. 2;

FIG. 6 is a schematic diagram showing the component layout of a 68-pin memory module according to the preferred embodiment of this invention; and

FIG. 7 is a schematic diagram showing the component layout of a terminal circuit module.

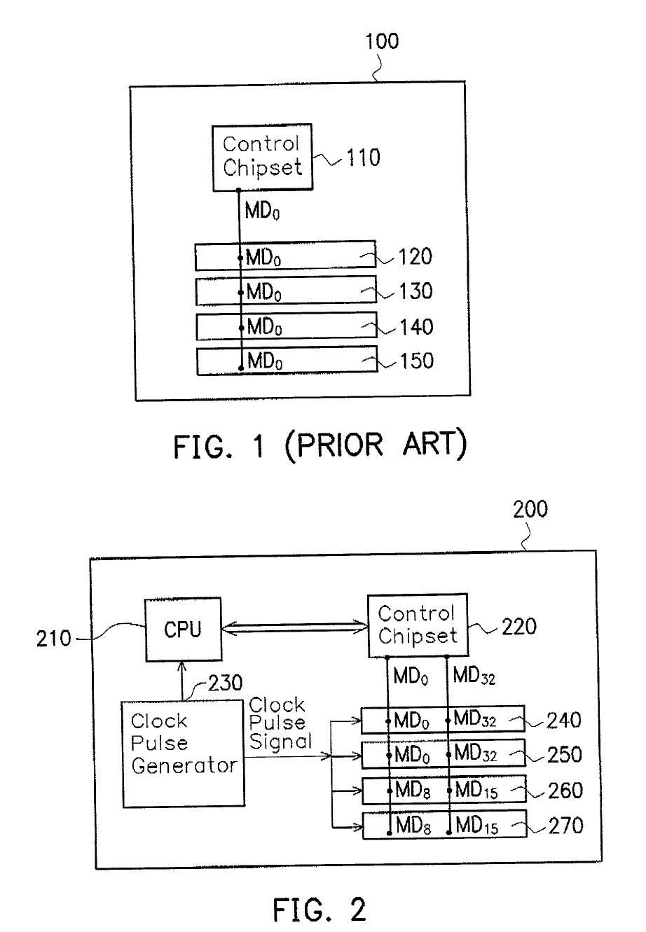

### DESCRIPTION OF THE PREFERRED EMBODIMENTS

Reference will now be made in detail to the present preferred embodiments of the invention, examples of which are illustrated in the accompanying drawings Wherever possible, the same reference numbers are used in the drawings and the description to refer to the same or like parts.

FIG. 2 is a schematic diagram showing various components inside a computer main board according to one preferred embodiment of this invention, In the embodiment of this invention, a main board 200 that includes a central processing unit (CPU) 210, a control chipset 220, a differential clock signal generator 230, a plurality of first type memory module slots 240-250 and a plurality of second type memory module slots 260-270 are provided. The control chipset 220 is used for supporting SDRAM/DDR DRAM memory modules and has a plurality of data pins M63 MD0. The differential clock signal generator 230 is used for generating differential clock signals needed by DDR DRAM memory module or normal clock signals needed by SDRANM. Each of the first type memory module slots 240-250 includes a plurality of data pins MD63-MD0. Each of the second type memory module slots 260-270 includes a plurality of data pins MD63-MD0, with the data pins all connected in parallel Data pin MD0 on control chipset 220 is connected sequentially to the data pin MD0 of first type memory module slots 240-250 and randomly to the data pin MD8 of second type memory module slots 260-270. In the followIng description, since the CPU 210 and the differential clock signal generator 230 is not a major concern in this invention, details of their operations are omitted First type memory module slots 240-250 can be 184-pin slots and second type memory slots 260-270 can be 168-pin slots.

Control chipset 220 on main board 200 is coupled to first type memory module slots 240-250 and second type memory module slots 260-270. Control chipset 220, first type memory module slots 240-250 and second type memory module s lots 260-270 all have a plurality of data pins MD63-MD0, However, the assignment of data pins MD63-MD0 for 184-pin memory module slots 240-250 and the assignment of data pins MD63-MD0 for 168-pin memory module slots 260-270 are different as shown in Table 1.

TABLE 1
Assignment of data pins MD63 ˜ MD0 for 184-pin memory module
slot and 168-pin memory module slot.

| 184 | 168 | 184 | 168 | 184 | 168 | 184 | 168 |
|---|---|---|---|---|---|---|---|
| MD3 | MD0 | MD46 | MD8 | MD27 | MD16 | MD10 | MD24 |
| MD59 | MD32 | MD47 | MD40 | MD31 | MD48 | MD11 | MD56 |
| MD62 | MD1 | MD42 | MD9 | MD26 | MD17 | MD14 | MD25 |
| MD58 | MD33 | MD43 | MD41 | MD30 | MD49 | MD15 | MD57 |
| MD61 | MD2 | MD45 | MD10 | MD25 | MD18 | MD12 | MD26 |
| MD57 | MD34 | MD41 | MD42 | MD29 | MD50 | MD13 | MD58 |
| MD60 | MD3 | MD40 | MD11 | MD24 | MD19 | MD8 | MD27 |
| MD56 | MD35 | MD44 | MD43 | MD28 | MD51 | MD9 | MD58 |
| MD55 | MD4 | MD39 | MD12 | MD19 | MD20 | MD7 | MD28 |
| MD51 | MD36 | MD35 | MD44 | MD23 | MD52 | MD3 | MD60 |
| MD54 | MD5 | MD34 | MD13 | MD18 | MD21 | MD2 | MD29 |
| MD50 | MD37 | M038 | MD45 | MD22 | MD53 | MD6 | MD61 |
| MD52 | MD6 | MD33 | MD14 | MD17 | MD22 | MD5 | MD30 |
| MD53 | MD38 | MD37 | MD46 | MD21 | MD54 | MD1 | MD62 |
| MD48 | MD7 | MD32 | MD15 | MD20 | MD23 | MD4 | MD31 |
| MD49 | MD39 | MD36 | MD47 | MD16 | MD55 | MD0 | MD63 |

As shown in FIG. 2, data pins MD62-MD0 of control chipset 220, 184-pin memory module slots 240-250 and 168-pin memory module slots 260-270 must all be connected. If data pins MD63-MD0 of 184-pin memory slots 240-250 are the main consideration, data pins MD63-MD0 of control chipset 220 must be connected to data pins MD63-MD0 of the 184-pin memory module slots 240-250 first before data pins MD63-MD0 of 168-pin memory module slots 260-270 are connected. However, as shown in Table 1, the assignment of positions between data pins MD63-MD0 of 184-pin memory module slots 240-250 and data pins MD63-MD0 of 168-pin memory module slots 260-270 are very different, Consequently, data pins MD63-MD0 of memory module slots 240-250 has to wire a longer distance in order to connect with data pins MD63-MD0 of memory module slots 260-270 This often leads to considerable difficulties in designing the layout around 168-pin memory module slots 260-270.

Beside providing innovative 184-pin and 168-pin memory modules slots for main board 200, control chipset 220 on main board 200 also provides a special write mode. The special write mode is used to deal with layout difficulties due to a difference in pin positions between memory modules. Data lines M63-MD0 of control chipset 220 are sequentially connected to data lines MD63-MD0 of 184-pin memory module slots 240-250. Data lines MD63-MD0 of 184-pin memory module slots 240-250 are randomly connected to data lines MD63-MD0 of 168-pin memory module slots 260-270. For example, data line MD0 on the 184-pin slot can connect with data line MD8 on the 168-pin slot. Similarly, MD1 connects with MD32 and MD2 connects with MD17. Hence, connection can be easily laid, size of the printed circuit board can be reduced and signal attenuation problem can be minimized, When the special write mode is in the activated mode and data need to be written from the control chipset to a memory module, the 64-bit data according to 64-bit block address is first read out. After the data is modified according to the read-out 64-bit data, the post-modified 64-bit -data are written into the memory module. The conditions for control chipset 220 to activate the special write mode are shown in Table 2.

The memory space is divided into a plurality of blocks in which the length of each block equals to the length of the data bus accessing the memory Each block is adjacent to each other, and the first block starts from address (0H), When the special write mode is activated, the control chipset reads/writes a data from/to the address of the first byte of the block in which the data is located, and the bit-length of the data equals to the bit-length of the block. For example, if the control chipset wants to write a byte data into address (0161H) and the length of data bus is 64 bit (8 bytes). The control chipset first reads 8-byte data (one block) from address (0160H), modifies the second byte of the 8-byte data, then writes back the whole block to address (0160). Above explains the terminology of “64-bit block address” mentioned earlier. Herein the block data is referred to “a complete bus data”.

TABLE 2
conditions for control chipset 220 to activate the special write mode.

| 184-pin memory module | 168-pin memory module | Special write mode |
|---|---|---|
| X2 | X0 | Not activated |
| X0 | X2 | Activated |
| X2 | X1 | Activated |
| X1 | X2 | Activated |

As shown in Table 2, the special write mode is deactivated only when 184-pin SDRAM or 184-pin DDR DRAM memory modules are plugged into 184-pin memory module slots 240-250 of main board 200 so that control chipset 220 and 184-pin memory module slots 240-250 can operate in a normal write mode. If 168-pin SDRAM or DDR DRAM memory modules are plugged into 168-pin memory module slots 260-270, or 168-pin SDRAM or DDR DRAM memory modules are plugged into both 184-pin memory module slots 240-250 and 168-pin memory module slots 260-270 of main board 200, the special write mode is activated by control chipset 220. Hence, special write mode is used between control chipset 220 and 184-pin memory module slots 240-250 as well as 168-pin memory module slots 260-270.

For example, to write a batch of 64-bit data into the memory module, if control chipset 220 is in the normal write mode, control chipset 220 will write the 64-bit data into the memory module plugged into 184-pin memory module slots 240-250 via data lines MD63-MD0. On the other hand, if control chipset 220 is in the special write mode, control chipset 220 must first read out a complete 64-bit (QW) data from the memory module of the target address having an 8-byte (QW) address condition. After modifying the to-be-written data, the fill 64-bit modified data is written back to the memory module at the target address. If the write data has a length shorter than 64-bit length such as an 8-bit or 16-bit length and control chipset 220 is in the special write mode, fill 64-bit data must be read from an 8-byte address first, After modifying the 8-bit or 16-bit data, a complete 64-bit data is written the memory module at the target address. Working under the special-write in mode may downgrade the performance of control chipset 220 by about 3%. However, in the special write mode, main board 200 can support both 184-pin memory module slots as well as 168-pin memory module slots. Hence, layout personnel can connect data lines MD63-MD0 between the 184-pin memory module slots and the 168-pin memory module slots with ease. Moreover, size of the printed circuit board can be reduced and signal attenuation problems can be minimized.

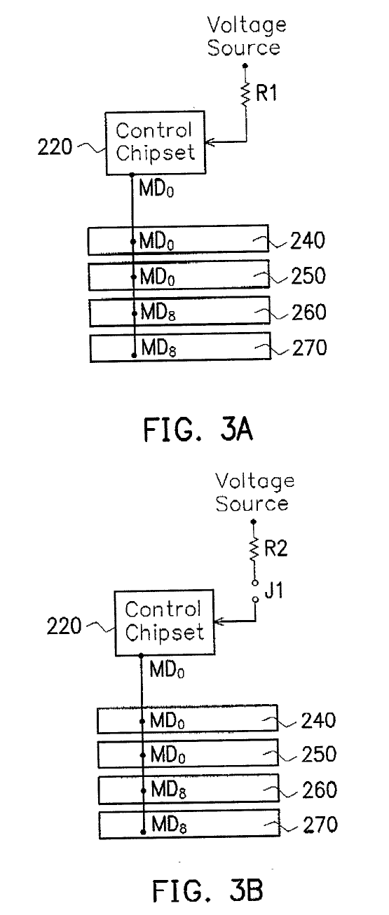

FIG. 3A is a block diagramn showing the activation of write mode by a resistor according to the preferred embodiment of this invention As shown in FIG. 3A, data pins MD63-MD0 on a control chipset 220 are sequentially connected to 184-pin memory module slot 240-250. For example, data line MD0 of control chipset 220 is connected sequentially with data line MD0 of a plurality of first type memory module slots 240-250 and randomly with data line MD8 of a plurality of second type memory module slots 260-270 The activation of the special write mode of this invention depends on an externally connected resistor R1 having connection with a voltage source, The voltage source can be 3.3 V, 2.5 V or 2.0 V, for example. When the special write pin of control chipset 220 is connected to a voltage source via a resistor R1, the special write mode will be activated no matter if data are to be written into the memory modules plugged into one of the 168-pin memory module slots 260-270 or into the memory modules plugged into one of the 184-pin memory module slots 240-250. If the special write pin of control chipset 220 is not connected to a voltage source via the resistor R1, control chipset 220 will not activate the special write mode.

FIG. 3B is a block diagram showing the activation of write mode in a computer main board by a jumper according to the preferred embodiment of this invention. As shown in FIG. 3B, activation of the special write mode depends on a jumper J1 serially connected to a resistor R2, which in turn is connected to a voltage source. The voltage source can be 3.3 V, 2.5 V or 2.0 V, for example. When the jumper J1 is short, the pin on control chipset 220 for special write mode is connected to a voltage source via the resistor R2. With the connection, the special write mode will be activated no matter if data must be written into the memory module in one of the 168-pin memory module slots 260 270 or into the memory module in one of the 184-pin memory module slots 240-250. On the other hand, when the jumper J1 is open, if the special write pin of control chipset 220 is not connected to a voltage source via the resistor R2, control chipset 220 will not activate the special write mode.

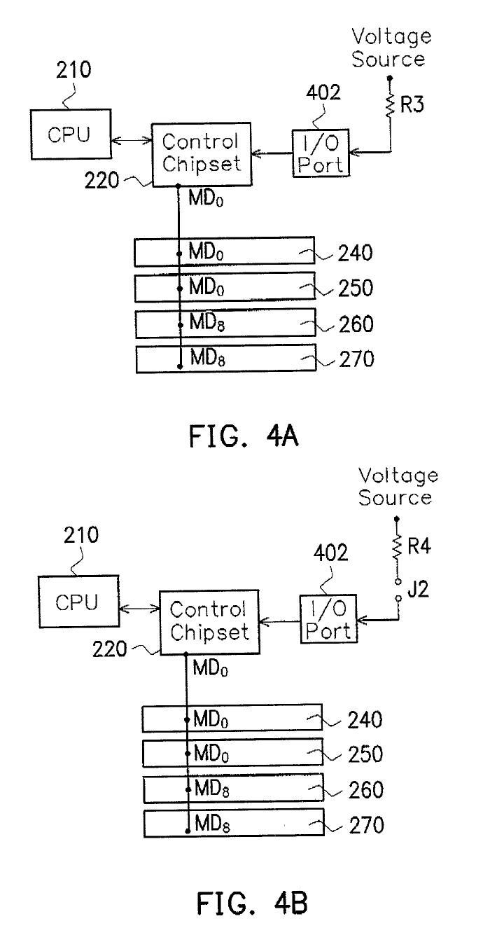

FIG. 4A is a block diagram showing the activation of write mode in a computer main board by an input/output port and a coupled resistor according to the preferred embodiment of this invention. As shown in FIG. 4A, the main board 200 includes a central processing unit (CPU) 210, a control chipset 220, a plurality of first type memory module slots 240-250, a plurality of second type memory module slots 260-270 and an input/output port 402 Control chipset 220 is coupled to CPU 210. Each first type memory module slot includes a plurality of data pins MD63-MD0 connected in parallel with each other. Similarly, each second type memory module slot includes a plurality of data pins MD63 MD0 connected in parallel with each other. The input/output port 402 is coupled to control chipset 220. The input/output port 402 has a special write pin. When the special write pin is connected to a set voltage via a resistor R3 and sensed by CPU 210, control chipset 220 will operate in a special write mode. On the contrary, if the special write pin of input/output port 402 is not connected to a preset voltage, control chipset 220 will operate in a normal write mode,

FIG. 4B is a block diagram showing the activation of write mode in a computer main board by an input/output port and a jumper according to the preferred embodiment of this invention. As shown in FIG. 4B, the main board 200 includes a central processing unit (CPU) 210, a control chipset 220, a plurality of first type memory module slots 240-250, a plurality of second type memory module slots 260-270 and an input/output port 402. Control chipset 220 is coupled to CPU 210. Each first type memory module slot includes a plurality of data pins MD63-MD0 connected in parallel with each other. Similarly, each second type memory module slot includes a plurality of data pins MD63-MD0 connected in parallel with each other. The input/output port 402 is coupled to control chipset 220, The input/output port 402 has a special write pin. When the special write pin is connected to a set voltage via a resistor R4 and a closed jumper J2 and sensed by CPU 210, control chipset 220 will operate in a special write mode. On the contrary, if jumper J2 is opened so that the special write pin of input/output port 402 is not connected to a preset voltage, control chipset 220 will operate in a nounal write mode.

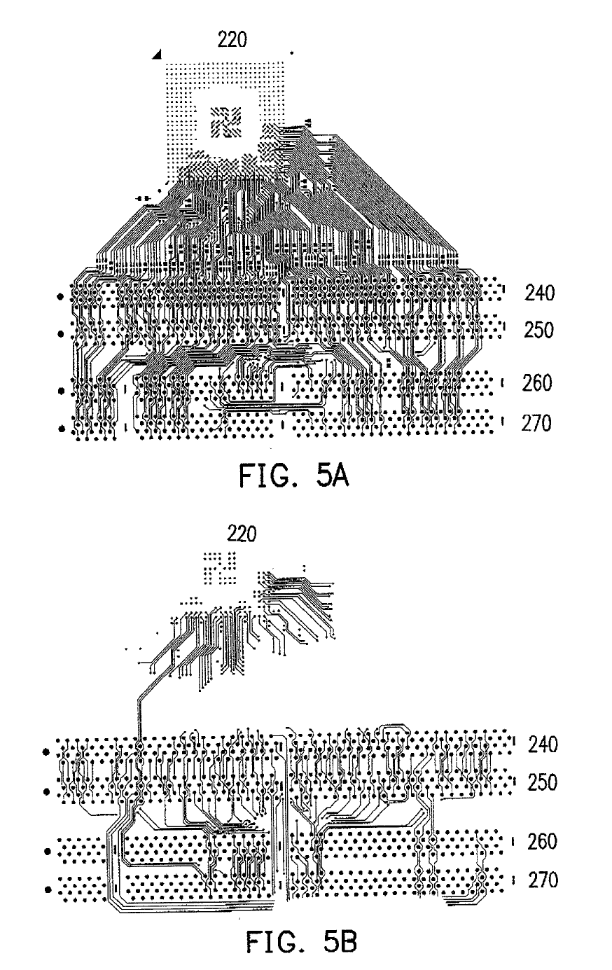

FIG. 5A is a portion of the circuit layout design on the component side of a computer main board according to the schematic diagram shown in FIG. 2. As shown in FIG. 5A, main board 200 of this invention provides a pair of 184-pin memory module slots 240-250 and a pair of 168-pin memory module slots 260-270. Since 184-pin memory module slots 240-250 are the principle target of design consideration in the invention, data pins MD63-MD0 on control chipset 220 connects sequentially with data lines MD63-MD0 of memory module slots 240-250 For example, data line MD63 on control chipset 220 connects with data line MD63 on memory module slots 240-250, and data line MD32 on control chipset 220 connects with MD32 on memory module slots 240-250 and so on. On the other hand, data lines MD63-MD0 on memory module slots 240-250 connects randomly with data lines MD63-MD0 on memory module slots 260-270. For example, data line MD63 on memory module slots 240-250 connects with data line MD0 on memory module slots 260-270, and data line MD32 on memory module slots 240-250 connects with data line MD15 on memory module slots 260-270 and so on. With this layout and the special write mode provided by control chipset 220, main board 200 of this invention is capable of supporting both 168-pin or 184-pin SDRAM and DDR DRAM memory modules. Furthermore, as shown in FIG. 5A, wiring connection between memory module slots 240-250 and memory module slots 260-270 is very much simplified, thereby reducing overall dimensions of the printed circuit board and minimizing signal attenuation In addition, those skilled in circuit design may note that the scope of this invention should also include the case having the connection between control chipset 220 and 168-pin memory module slots 260-270 as first consideration.

FIG. 5B is a portion of the circuit layout design on the backside of a computer main board according to the schematic diagram shown in FIG. 2 As shown in FIG. 5B, the circuit layout on the backside of main board 200 simplifies wiring connections between memory module slots 240-250 and memory module slots 260-270. Thus, the layout is able to reduce overall dimensions of the printed circuit and minimize signal attenuation.

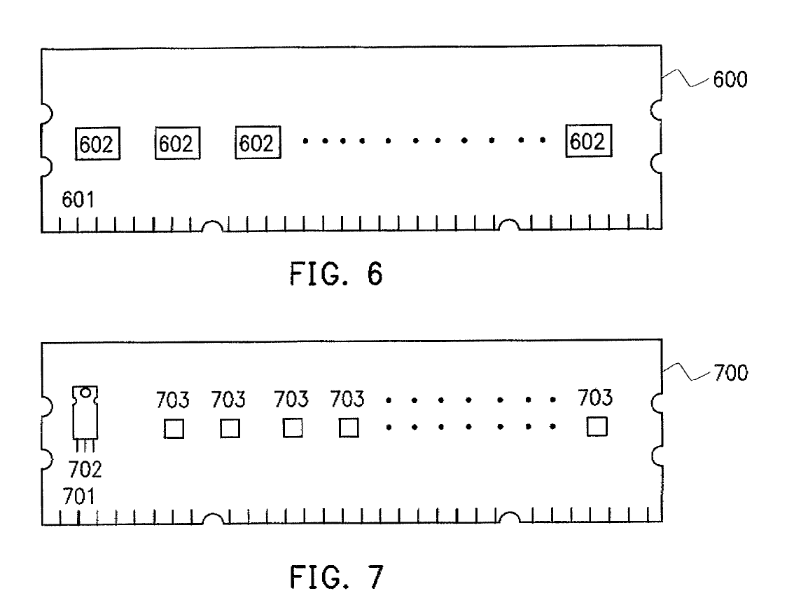

FIG. 6 is a schematic diagram showing the component layout of a 168-pin memory module according to the preferred embodiment of this invention Main board 200 of this invention can support 168-pin or 184-pin SDRAM and DDR DRAM memory modules. As shown in FIG. 6, the 168-pin DDR DRAM memory module 600 of this invention can be plugged into 168-pin memory module slots 260-270 on main board 200. The 168-pin DDR DRAM memory module 600 includes a printed circuit board 601 that can be plugged into memory module slots 260-270 and a plurality of DDR DRAM units 602 on printed circuit board 601. The undefined (NC) pin on the 168-pin slot is used to supplement necessary wiring connections for operating DDR DRAM memory module 600. When 168-pin DDR DRAM memory modules 600 of this invention are plugged into the memory module slots 260-270, control chipset 220 on main board 200 will activate the special write mode. Hence, control chipset 220 and 168-pin DDR DRAM memory modules 600 can operate together normally.

FIG. 7 is a schematic diagram showing the component layout of a terminal circuit module In this invention, a voltage regulator and a terminal resistor are installed inside a terminal circuit module so that some printed circuit area on main board 200 can be saved. Main board 200 of this invention can support 168-pin or 184-pin SDRAM and DDR DRAM memory modules. When DDR DRAM memory modules are used, a terminal circuit module must be plugged into one of the memory module slots 240-250 or one of the memory module slots 260-270. As shown in FIG. 7, terminal circuit module 700 can have 168 pins or 184 pins and a plurality of signal lines. Each terminal circuit modules 700 includes a printed circuit board 701, a voltage regulator 702 and a plurality of terminal resistors 703. Printed circuit board 701 can be plugged into any one of the memory module slots 240-270 to provide electrical connection between terminal circuit module 700 and memory module slots 240-270. Voltage regulator 702 on printed circuit board 701 is used for providing a terminal voltage. All terminal resistors 703 are placed on printed circuit board 701 and coupled to voltage regulator 702, One end of each terminal resistor 703 is connected to the signal lines while the other end is connected to the terminal voltage. In this invention, all memory module slots 240-250 on main board 200 meet JEDEC 184-pin specification, and all memory module slots 260-270 meet standard 168-pin specification, Memory modules slots 240-270 further includes a reference voltage pin position. When terminal circuit module 700 is plugged into any one of the memory module slots 240-270, voltage regulator 702 is able to provide the necessary reference voltage to the reference voltage pin. The reference voltage meets the permitted range specified in JEDEC SSTL_{—}2 bus specification, for example, at about 1.25 V.

This invention also provides a computer system that uses main board 200 and memory modules 600 and uses terminal circuit module 700 selectively so that SDRAM and DDR DRAM memory modules are supported concurrently. The computer system includes, a main board 200 having a plurality of memory module slots thereon, the memory module slots include: first type memory module slots 240-250 each having a plurality of data lines MD63-MD0, second type memory module slots 260-270 each having a plurality of data lines MD63-MD0; and, a control chipset 220 having a plurality of data lines MD63-MD0 coupled to first type memory module slots 240-250 and second type memory module slots 260-270, data lines MD63-MD0 of control chipset 220 connect with corresponding data lines MD63-MD0 of first type memory module slots 240-250 but connect randomly with data lines MD63-MD0 of second type memory module slots 260-270; a terminal circuit module 700 plugged into one of the second type memory module slots 260-270, terminal circuit module 700 includes; a printed circuit board 701 for providing electrical connection between terminal circuit module 700 and second type memory module slots 260-270; a voltage regulator 702 on printed circuit board 701 for providing a terminal voltage; and a plurality of terminal resistors 703 on printed circuit board 701 coupled to voltage regulator 702, one end of each resistor 703 connects with one of the data lines MD63-MD0 of second type memory module slots 260-270 while the other end of resistor 703 connects to the terminal voltage; and a memory module 600 plugged into one of the second type memory module slots 260-270, memory module 600 includes a plurality of DDR DRAM units 602. When data need to be written to memory module 600 via control chipset 220, a complete 64-bit data according to 64-bit block division is first read out from memory module 600. After modifying the 64-bit data, the complete 64-bit data is written into memory module 600. According to the computer system, all second type memory module slots 260-270 meet the standard specification for 168-pin memory module. Hence, both SDRAM and DDR DRAM memory modules are supported by the computer system.

This invention also provides a computer system that uses main board 200 and memory modules 600. The computer system includes: a main board 200 having a plurality of memory module slots thereon, the memory module slots include: first type memory module slots 240-250 each having a plurality of data lines MD63-MD0; second type memory module slots 260-270 each having a plurality of data lines MD63-MD0, and, a control chipset 220 having a plurality of data lines MD63-MD0 coupled to first type memory module slots 240-250 and second type memory module slots 260-270, data lines MD63-MD0 of control chipset 220 connect with corresponding data lines MD63-MD0 of first type memory module slots 240-250 but connect randomly with data lines MD63-MD0 of second type memory module slots 260-270; and a memory module 600 plugged into one of the second type memory module slots 260-270, memory module 600 includes a plurality of SDRAM units 602. When data need to be written to memory module 600 via control chipset 220, a complete 64-bit data according to 64-bit block division is first read out from memory module 600. After modifying the 64-bit data, the complete 64-bit data is written into memory module 600. According to the computer system, all second type memory module slots 260-270 meet the standard specification for 168-pin memory module.

This invention also provides a computer system that uses main board 200 and memory modules 600. The computer system includes: a main board 200 having a plurality of memory module slots thereon, the memory module slots include: first type memory module slots 240-250 each having a plurality of data lines MD63-MD0; second type memory module slots 260-270 each having a plurality of data lines MD63-MD0; and, a control chipset 220 having a plurality of data lines MD63-MD0 coupled to first type memory module slots 240-250 and second type memory module slots 260-270, data lines MD63-MD0 of control chipset 220 connect with corresponding data lines MD63-MD0 of first type memory module slots 240-250 but connect randomly with data lines MD63-MD0 of second type memory module slots 260-270, control chipset 220 has a special wvrite mode, and on activation of the to special write mode for writing data via control chipset 220, a complete 64-bit data according to 64-bit block division is first read out and modified before writing the complete 64-bit data; and a memory module 600 plugged into one of the first type memory module slots 240-250, memory module 600 includes a plurality of SDRAM units 602. According to the computer system, all second type memory module slots 260-270 meet the standard specification for 168-pin memory module.

This invention also provides a computer system that uses main board 200 and memory modules 600 and uses terminal circuit module 700 selectively so that SDRAM and DDR DRAM memory modules are supported concurrently. The computer system includes: a main board 200 having a plurality of memory module slots thereon, the memory module slots include: first type memory module slots 240-250 each having a plurality of data lines MD63-MD0; second type memory module slots 260-270 each having a plurality of data lines MD63-MD0; and, a control chipset 220 having a plurality of data lines MD63-MD0 coupled to first type memory module slots 240-250 and second type memory module slots 260-270, data lines MD63-MD0 of control chipset 220 connect with corresponding data lines MD63-MD0 of first type memory module slots 240-250 but connect randomly with data lines MD63-MD0 of second type memory module slots 260-270, control chipset 220 has a special write mode, and on activation of the special write mode for writing data via control chipset 220, a complete 64-bit data according 64-bit block division is first read out and modified before writing the complete 64-bit data; a terminal circuit module 700 plugged into one of the first type memory module slots 240-250, terminal circuit module 700 includes: a printed circuit board 701 for providing electrical connection between terminal circuit module 700 and first type memory module slots 240-250; a voltage lo regulator 702 on printed circuit board 701 for providing a terminal voltage; and a plurality of terminal resistors 703 on printed circuit board 701 coupled to voltage regulator 702, one end of each resistor 703 connects with one of the data lines MD63-MD0 of first type memory module slots 240-250 while the other end of resistor 703 connects to the terminal voltage; and a memory module 600 plugged into one of the first type memory module slots 240-250, memory module 600 includes a plurality of DDR DRAM units 602. According to the computer system, all first type memory module slots 240-250 meet the standard specification for 184-pin memory module.

Note that when DDR DRAM is used in this invention, a matching terminal circuit module 700 must be used. The terminal circuit module 700 must be positioned in one of the memory module slots 240-270 whose distance, compared with the DDR DRAM memory modules, must be firthest from CPU 220. Moreover, no matter if SDRAM or DDR DRAM is used, the memory modules in the slots of main board 200 must correctly set the special write mode to ensure the correctness of data. In addition, a pair of 184-pin and a pair of 168-pin memory module slots are drawn on main board 200, However, anyone familiar with the technology may notice that the number of memory module slots is unlimited. For example, a design having three 168-pin memory module slots is equally feasible, Considering the finction of DRAM in a computer system, data within a DRAM unit on computer system startup is undefined. Any useful data in the DRAM must be written in after system startup. Since circuit design of main board 200, CPU 220 and control chipset 220 all follow the aforesaid layout arrangement, data read-out will be free from problems as tong as write data is correct. In this invention, control chipset 220 will process data in the memory modules of 168-pin memory module slots 260 270 in a special write mode. In other words, no matter if 64-bit data or data of other bit length need to be written, a complete 64-bit data according to 64-bit block division is first read out and modified before writing the complete 64-bit data. Hence, confusion in layout will hardly affect accuracy of data write operations.

In summary, this invention provides a main board having a plurality of types of memory module slots and a computer system that has a few advantages over conventional techniques. According to this invention, user is capable of plugging 168-pin and 184-pin SDRAM memory modules or 168-pin and 184-pin DDR DRAM memory modules into the slots of a computer main board.

The control chipset on the main board of this invention provides a special write mode. Hence, the plurality of data pins MD63-MD0 of the control chipset can connect sequentially with data pins MD63-MD0 of 184-pin memory module slots but connect randomly with data pins MD63-MD0 of 168-pin memory module slots Through the special write mode provided by the control chipset, conflising wiring layout has no effect on the accuracy of writing operations. Thus, the computer system can operate correctly.

DDR DRAM memory module requires a voltage regulator and a plurality of pull-up resistors The terminal circuit module of this invention permits main board manufacturers to integrate a voltage regulator and a plurality of pull-up resistors together so that area occupation of printed circuit board on a mnain board is reduced According to the design of 168-pin memory module in this invention, memory module manufacturers can plug DDR DRAM memory modules into 168-pin slots originally intended for SDRAM memory modules, Together with the aforementioned terminal circuit modules DDR DRAM memory modules can also be used on a main board having 168-pin memory module slots.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A main board, comprising:
a first type memory module slot having a plurality of data pins,
a second type memory module slot having a plurality of data pins, and
a control chipset having a plurality of data pins coupled to the first type memory module slot and the second type memory module slot, wherein the data pins of the control chipset connects with corresponding data pins of the first type memory module slot and randomly connects with the data pins of the second type memory module slot, and the control chipset has a special write mode such that a complete bus data is read out, modified and then written in a memory module plugged on the first type or the second type memory module slot when the special write mode is activated.

2. The main board of claim 1, wherein the complete bus data has a length of 64 bits.

3. The main board of claim 1, wherein the first type memory module slot meets JEDEC 184-pin memory module slot specification.

4. The main board of claim 1, wherein the second type memory module slot meets 168-pin memory module slot specification.

5. The main board of claim 1, wherein the first type memory module slot meets 224-pin memory module slot specification.

6. The main board of claim 1, wherein the control chipset can be set to control the memory module plugged on the second/first type memory module slot so that the special write mode can be activated or terminated.

7. The main board of claim 6, wherein the control chipset can be set such that the special write mode is activated to access data in memory module plugged into the second type memory module slot.

8. The main board of claim 6, wherein the control chipset is set by a basic input/output system (BIOS) to control the memory module plugged on the second/first type memory module slot so that the special write mode can be activated or terminated.

9. The main board of claim 6, wherein the control chipset further includes a special write pin through which special write mode can be activated or terminated.

10. The main board of claim 6, wherein the main board further includes a central processing unit (CPU) and a register, the CPU is able to set the register so that the special write mode can be activated or terminated.

11. A terminal circuit module that can be applied to a main board having a 168-pin memory module slot with a plurality of signal lines, comprising;
a printed circuit board that can plug into the memory module slot for providing electrical connection between the terminal circuit module and the memory module slot a voltage regulator on the printed circuit board for providing a terminal voltage, and
a plurality of terminal resistors on the printed circuit board coupled to the voltage regulator, wherein one end of each terminal resistor connects to one of the signal lines while the other end of each terminal resistor connects to the terminal voltage.

12. A memory module for a main board having 168-pin memory module slot, comprising:
a printed circuit board that can plug into the memory module board; and
a plurality of double-data-rate dynamic random access memory (DDR DRAM) on the printed circuit board.

13. A computer system, comprising;
a main board, comprising:
a first type memory module slot having a plurality of data pins;
a plurality of second type memory module slots, each having a plurality of data pins; and
a control chipset coupled to the first type memory module slot and the second type memory module slots, wherein the control chipset has a plurality of data pins such that the data pins of the control chipset connect with corresponding data pins of the first type memory module slot and randomly connect with the data pins of the second type memory module slots;
a terminal circuit module plugged into one of the second memory module slots, comprising;
a printed circuit board for providing electrical connection between the terminal circuit module and the second type memory module slots;
a voltage regulator on the printed circuit board for providing a terminal voltage; and
a plurality of terminal resistors on the printed circuit board coupled to the voltage regulator, wherein one end of each terminal resistor connects to one of the data pins of the second type memory module slots while the other end of the terminal resistor connects to the terminal voltage; and
a memory module plugged into one of the second type memory module slots, wherein the memory module includes a plurality of double-data-rate dynamic random access memory units;
when data need to be written by the control chipset into one of the memory modules, a complete bus data is read out from the memory module and then modified before writing back to the memory module.

14. The computer system of claim 13, wherein the complete bus data has a length of 64 bits.

15. The computer system of claim 13, wherein the second type memory module slot meets 168-lead memory module slot specification.

16. A computer system, comprising:
a main board, comprising:
a first type memory module slot having a plurality of data pins;
a second type memory module slot having a plurality of data pins; and
a control chipset coupled to the first type memory module slot and the second type memory module slot, wherein the control chipset has a plurality of data pins such that the data pins of the control chipset connect with corresponding data pins of the first type memory module slot and randomly connect with the data pins of the second type memory module slot; and
a memory module plugged into the second type memory module slot, wherein the memory module includes a plurality of synchronous dynamic random access memory units, when data need to be written by the control chipset into one of the memory modules, a complete bus data is read out from the memory module and then modified before writing back to the memory module.

17. The computer system of claim 16, wherein the complete bus data has a length of 64 bits.

18. The computer system of claim 16, wherein the second type memory module slot meets 168-pin memory module slot specification.

19. A computer system, comprising:
a main board, comprising:
a first type memory module slot having a plurality of data pins;
a second type memory module slot having a plurality of data pins; and
a control chipset coupled to the first type memory module slot and the second type memory module slot, wherein the control chipset has a plurality of data pins such that the data pins of the control chipset connect with corresponding data pins of the first type memory module slot and randomly connect with the data pins of the second type memory module slot, the control chipset includes a special write mode and when the special write mode is activated, a complete bus data is read out from the memory module and then modified before writing back to the memory module; and
a memory module plugged into the first type memory module slot, wherein the memory module includes a plurality of synchronous dynamic random access memory units.

20. The computer system of claim 19, wherein the complete bus data has a length of 64 bits.

21. The computer system of claim 19, wherein the first type memory module slot meets 184-pin memory module slot specification.

22. A computer system, comprising:
a main board, comprising:
a plurality of first type memory module slots each having a plurality of data pins;
a second type memory module slot having a plurality of data pins; and
a control chipset coupled to the first type memory module slots and the second type memory module slot, wherein the control chipset has a plurality of data pins such that the data pins of the control chipset connect with corresponding data pins of the first type memory module slot and randomly connect with the data pins of the second type memory module slots, the control chipset includes a special write mode and when the special write mode is activated, a complete bus data is first read out from the memory module and then modified before writing back to the memory module;
a terminal circuit module plugged into one of the first memory module slots, comprising:
a printed circuit board for providing electrical connection between the terminal circuit module and the first type memory module slots;
a voltage regulator on the printed circuit board for providing a terminal voltage; and
a plurality of terminal resistors on the printed circuit board coupled to the voltage regulator, wherein one end of each terminal resistor connects to one of the data pins of the first type memory module slots while the other end of the resistor connects to the terminal voltage; and
a memory module plugged into one of the first type memory module slots, wherein the memory module includes a plurality of double-data-rate dynamic random access memory units.

23. The computer system of claim 22, wherein the complete bus data has a length of 64 bits.

24. The computer system of claim 22, wherein the first type memory module slots meets 184-pin memory module slot specification.

25. A computer system, comprising:
a main board, comprising:
a plurality of first type memory module slots each having a plurality of data pins;
a second type memory module slot having a plurality of data pins; and
a control chipset coupled to the first type memory module slots and the second type memory module slot, wherein the control chipset has a plurality of data pins such that the data pins of the control chipset connect with corresponding data pins of the first type memory module slot and randomly connect with the data pins of the second type memory module slots, the control chipset includes a special write mode and is when the special write mode is activated, a complete bus data is read out from the memory module and then modified before writing back to the memory module;
a terminal circuit module plugged into the second memory module slot, comprising:
a printed circuit board for providing electrical connection between the terminal circuit module and the first type memory module slots;
a voltage regulator on the printed circuit board for providing a terminal voltage; and
a plurality of terminal resistors on the printed circuit board coupled to the voltage regulator, wherein one end of each terminal resistor connects to one of the data pins of the second type memory module slot while the other end of each terminal resistor connects to the terminal voltage; and
a memory module plugged into one of the first type memory module slots, wherein the memory module includes a plurality of double-data-rate dynamic random access memory units.

26. The computer system of claim 25, wherein the complete bus data has a length of 64 bits.

27. The computer system of claim 25, wherein the first type memory module slot meets 184-pin memory module slot specification.

28. The computer system of claim 25, wherein the second type memory module slot meets 168-pin memory slot specification.

29. A computer system, comprising:
a main board, comprising:
a plurality of first type memory module slots each having a plurality of data pin;
a second type memory module slot having a plurality of data pins; and
a control chipset coupled to the first type memory module slots and the second type memory module slot, wherein the control chipset has a plurality of data pins such that the data pins of the control chipset connect with corresponding data pins of the first type memory module slot and randomly connect with the data pins of the second type memory module slots, the control chipset includes a special write mode and when the special write mode is activated, a complete bus data is first read out from the memory module and then modified before writing back to the memory module;
a terminal circuit module plugged into the first memory module slots, comprising:
a printed circuit board for providing electrical connection between the terminal circuit module and the first type memory module slots;
a voltage regulator on the printed circuit board for providing a terminal voltage; and
a plurality of terminal resistors on the printed circuit board coupled to the voltage regulator, wherein one end of each terminal resistor connects to one of the data pins of the first type memory module slot while the other end of each terminal resistor connects to the terminal voltage; and
a memory module plugged into one of the second type memory module slot, wherein the memory module includes a plurality of double-data-rate dynamic random access memory units

30. The computer system of claim 29, wherein the complete bus data has a length of 64 bits.

31. The computer system of claim 29, wherein the first type memory module slot meets 184-pin memory module slot specification.

32. The computer system of claim 29, wherein the second type memory module slot meets 168-pin memory slot specification.
